(19) United States
(12) Patent Application Publication
(10) Pub. No.: US 2015/0195016 A1
(43) Pub. Date: Jul. 9, 2015

(54) LINE OF SIGHT (LOS) MULTIPLE-INPUT AND MULTIPLE-OUTPUT (MIMO) SYSTEM FOR REDUCING DISTANCE SEPARATING ANTENNAS

(71) Applicant: Electronics and Telecommunications Research Institute, Daejeon (KR)

(72) Inventors: Bong Su KIM, Daejeon (KR); Woo Jin BYUN, Daejeon (KR); Min Soo KANG, Daejeon (KR); Kwang Seon KIM, Daejeon (KR); Jong Soo LIM, Daejeon (KR)

(21) Appl. No.: 14/592,601

(22) Filed: Jan. 8, 2015

(30) Foreign Application Priority Data
Jan. 9, 2014 (KR) 10-2014-0002832

(51) Int. Cl. H04B 7/04; H04B 7/06

(52) U.S. Cl. CPC H04B 7/0413; H04B 7/0671

(57) ABSTRACT

A line of sight (LOS) multiple-input and multiple-output (MIMO) system and a method of designing the system are provided, wherein a MIMO transmitter may include N transmission antennas, and an output transfer function of the MIMO transmitter may be adjusted based on phase difference between a direct path from each of the N transmission antennas to each of the M reception antennas and a delay path from each of the N transmission antennas to each of the M reception antennas.

### CROSS-REFERENCE TO RELATED APPLICATION

This application claims the priority benefit of Korean Patent Application No. 10-2014-0002832, filed on Jan.9, 2014, in the Korean Intellectual Property Office, the disclosure of which is incorporated herein by reference.

### BACKGROUND

1. Field of the Invention

Embodiments of the present invention relate to a line of sight (LOS) multiple-input and multiple-output (MIMO) system and a method of designing the same.

2. Description of the Related Art

An increasing amount of data usage has resulted in a long-term lack of frequencies. Various forms of research have been conducted on a method of using, for example, a high-order modulation scheme, multiple-input and multiple-output (MIMO) technology, a signal separation scheme based on a polarized wave, and the like, thereby improving an actual frequency efficiency.

The MIMO technology may be designed to provide relatively high performance in an independent environment without an inter-channel correlationship causing multi-path fading in a low frequency band to which a cellular, a wireless local area network (WLAN), and the like is applied. However, due to a continuous increase in the frequency, performing a MIMO operation in a line of sight (LOS) channel environment is being attempted.

In a related art, for example, U.S. Pat. No. 7,006,804 (High-speed two-way point-to-point transmission) discloses MIMO technology for use in a point-to-point wireless link for high speed data transmission. For example, in contrast to existing MIMO technology using multi-path fading in a cellular environment, a method of high speed transmission using a plurality of antennas in a point-to-point system including an LOS path is disclosed therein.

### SUMMARY

In an existing line of sight (LOS) multiple-input and multiple-output (MIMO) method, antennas may be disposed such that a transmission delay between a direct path and a delay path is set to be 90 degrees (°) and thus, an inter-path correlationship may be maintained. Through this, an original signal may be restored by processing a received signal. However, since a distance separating the antennas is determined based on a transmission distance and a wavelength of a wireless transmission frequency, the distance may need to be adjusted during each installation of the antennas.

An aspect of the present invention provides an LOS MIMO system to transmit a combination of a plurality of signals using each antenna, and restore a signal received through an LOS channel environment by performing a simple operation, thereby appropriately adjusting a distance separating antennas.

According to an aspect of the present invention, there is provided a MIMO transmitter including N transmission antennas, wherein an output transfer function of the MIMO transmitter is adjusted based on phase difference between a direct path from each of the N transmission antennas to each of the M reception antennas and a delay path from each of the N transmission antennas to each of the M reception antennas.

The output transfer function may be adjusted such that a phase difference between a signal received by each of the M reception antennas through the delay path and a signal received by each of the M reception antennas through the direct path is a multiple of 90°.

Each of the M reception antennas may be disposed to have an identical difference between the direct path from each of the N reception antennas and the delay path from each of the N reception antennas.

The N transmission antennas may be disposed not to form a center alignment relative to the M reception antennas.

The N transmission antennas may be disposed such that a distance separating the N transmission antennas differs from a distance separating the M reception antennas. The output transfer function of the MIMO transmitter may be expressed to be H_{adjust}=Hᵣₑₐₗ⁻¹H_{ideal}, and wherein Hᵣₑₐₗ⁻¹ denotes a reverse function of an actual channel transfer function of the N transmission antennas and the M reception antennas, and H_{ideal} denotes a transfer function through which a phase difference between a signal received through the direct path and a signal received through the delay path is set to be 90°.

When N is “2” and M is “2”, H_{ideal} may be expressed to be

$${H}_{ideal} = [ \begin{matrix}1 & {e}^{i \frac{π}{2}} \\ {e}^{i \frac{π}{2}} & 1\end{matrix} ] ,$$

Hᵣₑₐₗ⁻¹ is expressed to be

$${H}_{real} = [ \begin{matrix}1 & {e}^{i θ} \\ {e}^{i θ} & 1\end{matrix} ] ,$$

and θ denotes an actual phase difference between the direct path and the delay path.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a line of sight (LOS) multiple-input and multiple-output (MIMO) system according to a related art;

FIG. 2 is a diagram illustrating an operation of an LOS MIMO system according to an embodiment of the present invention;

FIGS. 3A and 3B are diagrams illustrating an operation of an LOS MIMO system based on a distance between a transmission antenna and a reception antenna, and center alignment distortion occurring between the transmission antenna and the reception antenna according to an embodiment of the present invention; and

FIG. 4 is a diagram illustrating a 4×4 LOS MIMO system according to an embodiment of the present invention.

### DETAILED DESCRIPTION

Hereinafter, descriptions about a line of sight (LOS) multiple-input and multiple-output (MIMO) system for reducing a distance separating antennas will be provided with reference to the accompanying drawings.

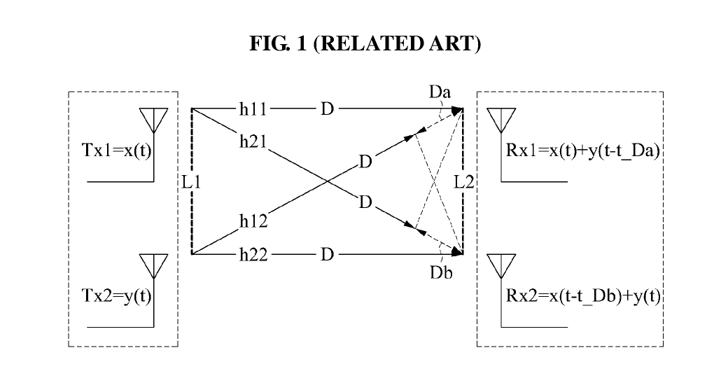

FIG. 1 is a diagram illustrating an LOS MIMO system according to a related art. Descriptions will be provided based on a 2×2 MIMO system for increased clarity and conciseness.

A signal transmitted from a transmission antenna Tx1 may be transmitted to a reception antenna Rx1 and a reception antenna Rx2 through an LOS channel. In this example, a transmission path of a channel h21 may be installed to have a length longer than that of a channel h11 by a length Da. In a case of a transmission antenna Tx2, a transmission path of a channel h12 may be installed to have a length longer than that of a channel h22 by a length Db. Thus, a length of Da+Db may be expressed in terms of a distance L1 between the transmission antenna Tx1 and the transmission antenna Tx2, a distance L2 between the reception antenna Rx1 and the reception antenna Rx2, and D as shown in Equation 1.

Da+Db=(nλD)/2 [Equation 1]

In Equation 1, n denotes a natural number, and) denotes a wavelength of a transmission signal. When n is “1”, a minimum length of Da+Db may be obtained in Equation 1.

To obtain a minimum length of Da+Db, each antenna may be disposed such that a phase of a path of the channel h21 is greater than a phase of a path of the channel h11 by 90 degrees (°) and thus, signals input from the transmission antenna Tx1 and the transmission antenna Tx2 to the reception antenna Rx1 and the reception antenna Rx2 may be easily recognized to be a signal of the transmission antenna Tx1 and a signal the transmission to antenna Tx2.

In an embodiment, when a transmission distance between a transmission antenna and a reception antenna at a frequency of 12.45 gigahertz (GHz) is 2 kilometers (km), the distance may be calculated to be L1=L2=5 m. Thus, practical antenna installation may be faced with numerous restrictions, and a distance between antennas may need to be adjusted for each time of changing a transmission distance.

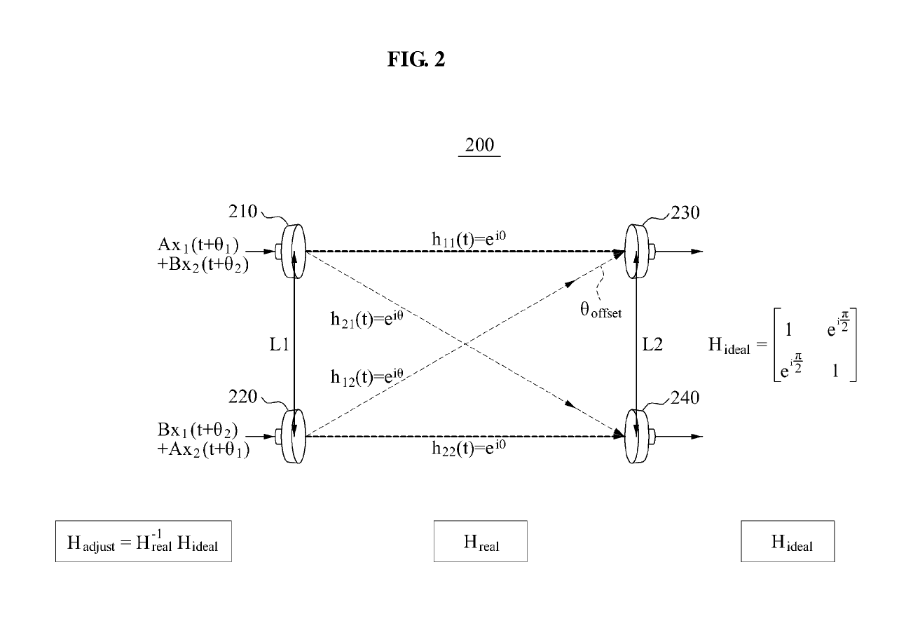

FIG. 2 is a diagram illustrating an operation of an LOS MIMO system according to an embodiment of the present invention. Hereinafter, descriptions about an operational principle of an LOS MIMO system 200 having a 2×2 structure will be provided.

Referring to FIG. 2, each of a channel h11, starting from a transmission antenna 210 to a reception antenna 230 and a channel h22, starting from a transmission antenna 220 to a reception antenna 240 may correspond to a direct path. Each of a channel 21, starting from the transmission antenna 210 to the reception antenna 240 and a channel 12, starting from the transmission antenna 220 to the reception antenna 230 may correspond to a delay path.

In FIG. 1, two signals may be received from transmission antennas restored by adjusting a distance between a transmission antenna and a reception antenna such that a signal phase difference between a direct path and a delay path is set to be 90°. When the signal phase difference is 90°, practical antenna installation may be faced with numerous restrictions.

The distance between the transmission antenna and the reception antenna may be reduced based on example embodiments of the present invention.

An existing channel function for the LOS MIMO system may be expressed as Equation 2.

$${H}_{ideal} = [ \begin{matrix}1 & {e}^{i \frac{π}{2}} \\ {e}^{i \frac{π}{2}} & 1\end{matrix} ] \qquad [ Equation 2 ]$$

The channel function of Equation 2 may be a transfer function of an LOS MIMO system having a path difference of 90°. In a reception antenna, a transmission signal may be restored by receiving the transfer function of Equation 2.

In an embodiment, the reception antenna may receive an identical transfer function to Equation 2 by adjusting an output transfer function of the transmission antenna. In this example, the path difference may not be limited to 90°, and an actual transfer function may be expressed to be Equation 3.

$${H}_{real} = [ \begin{matrix}1 & {e}^{i θ} \\ {e}^{i θ} & 1\end{matrix} ] \qquad [ Equation 3 ]$$

Based on Equations 2 and 3, the output transfer function of the transmission antenna may be obtained as shown in Equation 4.

H_{adjust}=Hᵣₑₐₗ⁻¹H_{ideal} [Equation 4]

In an embodiment, since each function of Equations 2 and 3 corresponds to a 2×2 matrix, a transfer function of Equation 4 may have a form of a 2×2 matrix. Based on Equation 4, a phase of intensity of a different signal to be transmitted from each antenna may be adjusted, added up, and output to an antenna, thereby acquiring an identical performance to an existing LOS MIMO system.

A phase difference between the transmission antenna and the reception antenna may not be limited to 90°. For example, a signal transmitted from the transmission antenna may be restored irrespective of a numerical value such as 30°, 45°, 60°, and the like. Thus, the distance between the transmission antenna and the reception antenna may be adjusted as necessary.

In an embodiment, a transfer function of the transmission antenna may be calculated with respect to 30°, 45°, and 60° as shown in Equation 5.

$${H}_{real} phase \text{:} 45 degrees \\ {H}_{real} = [ \begin{matrix}1 & {e}^{i \frac{π}{4}} \\ {e}^{i \frac{π}{4}} & 1\end{matrix} ] {H}_{adjust} = [ \begin{matrix}1.3066 {e}^{i \frac{22.5}{180} π} & 0.5412 {e}^{i \frac{202.5}{180} π} \\ 0.5412 {e}^{i \frac{202.5}{180} π} & 1.3066 {e}^{i \frac{22.5}{180} π}\end{matrix} ] \\ {H}_{real} phase \text{:} 30 degrees \\ {H}_{real} = [ \begin{matrix}1 & {e}^{i \frac{π}{6}} \\ {e}^{i \frac{π}{6}} & 1\end{matrix} ] {H}_{adjust} = [ \begin{matrix}1.7321 {e}^{i \frac{30}{180} π} & 1 {e}^{i \frac{210}{180} π} \\ 1 {e}^{i \frac{210}{180} π} & 1.7321 {e}^{i \frac{30}{180} π}\end{matrix} ] \\ {H}_{real} phase \text{:} 60 degrees \\ {H}_{real} = [ \begin{matrix}1 & {e}^{i \frac{π}{3}} \\ {e}^{i \frac{π}{3}} & 1\end{matrix} ] {H}_{adjust} = [ \begin{matrix}1.1154 {e}^{i \frac{15}{180} π} & 0.2989 {e}^{i \frac{195}{180} π} \\ 0.2989 {e}^{i \frac{195}{180} π} & 1.1154 {e}^{i \frac{15}{180} π}\end{matrix} ] \qquad [ Equation 5 ]$$

The transfer function may be obtained based on Equation 4. Also, the transfer function of the transmission antenna may be obtained with respect to another phase difference without limiting the phase difference of the distance between the transmission antenna and the reception antenna, to 30°, 45°, and 60°

Hereinafter, descriptions about an alignment distortion occurring between the transmission antenna and the reception antenna due to inaccurate installation or swaying of an antenna due to wind will be provided.

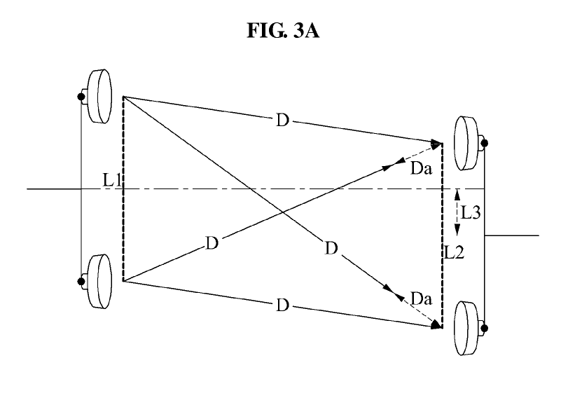

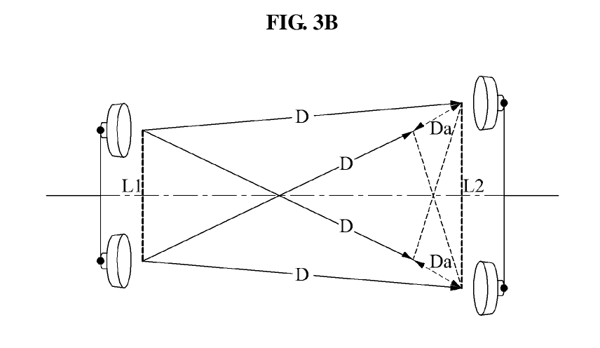

FIGS. 3A and 3B are diagrams illustrating an operation of an LOS MIMO system based on a distance between a transmission antenna and a reception antenna, and a center alignment distortion occurring between the transmission antenna and the reception antenna according to an embodiment of the present invention. Performance of the LOS MIMO system affected by the center alignment distortion occurring between the transmission antenna and the reception antenna may be described with reference to FIG. 3A. Performance of the LOS MIMO system affected by the distance between the transmission antenna and the reception antenna may be described with reference to FIG. 3B.

Referring to FIG. 3A, since each antenna has an identical distance difference Da between a direction path and a delay path, a signal may be restored normally in the reception antenna when centers of antennas are not matched to each other because a center is moved by L3.

In an existing LOS MIMO system, when the center is relocated as described in FIG. 3A, performance distortion may occur due to a failure in maintaining a phase difference of Da to be 90°.

Referring to FIG. 3B, an interval L1 between transmission antennas may differ from an interval L2 between reception antennas. In an existing LOS MIMO system, performance distortion may occur when a phase difference of a distance difference Da between a direct path and a delay path is not maintained to be 90°. According to an embodiment of the present invention, since each of the reception antennas may have an identical distance difference Da, a signal transmitted from the transmission antenna may be restored normally in the reception antenna.

Accordingly, in a practical field installation of a transmitter and a receiver, an antenna may be installed without location restrictions.

Hereinafter, descriptions about a method of designing a transmitter and a receiver will be provided. In an embodiment, each of the transmitter and the receiver may include at least two antennas, and a number of antennas of the transmitter may differ from a number of antennas of the receiver.

The transmitter may be designed such that each transmission antenna is disposed at a predetermined interval. Transmission antennas of the transmitter may be disposed not to form a center alignment relative to reception antennas of the receiver.

In a process of designing the receiver, a phase difference between a signal received by the reception antenna through a delay path and a signal received by the reception antenna through a direct path may be adjusted to be a multiple of 90°. In an embodiment, the receiver may be designed such that the reception antenna receives a transfer function of an LOS MIMO system having a path difference of 90°.

The transmission antennas may be disposed such that a distance separating the transmission antennas differs from a distance separating the reception antennas. Also, each of the reception antennas may be disposed to have an identical difference between the direct path from each of the reception antennas and the delay path from each of the reception antennas.

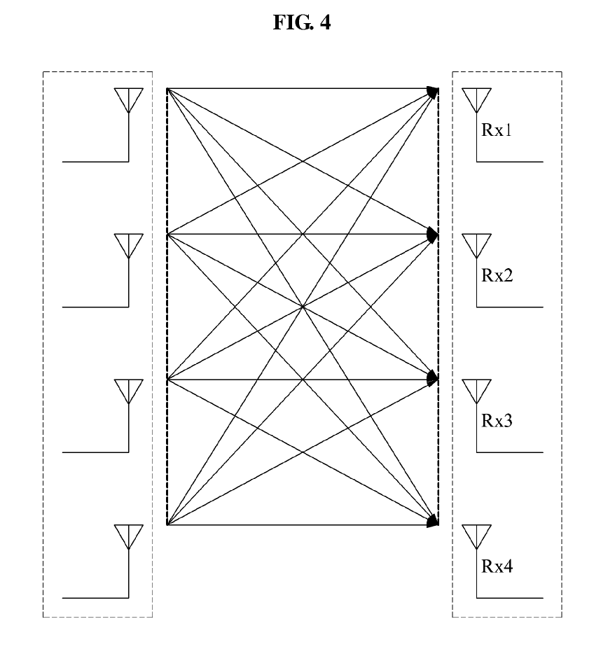

FIG. 4 is a diagram illustrating a 4×4 LOS MIMO system according to an embodiment of the present invention. An LOS MIMO system according to an example embodiment may be extended to an N×M MIMO environment.

Referring to FIG. 4, a transmitter and a receiver for achieving a desired result without performance distortion in a process of signal restoring despite a center alignment between a transmission antenna and a reception antenna, and a difference between a distance separating transmission antennas. Thus, a distance separating reception antennas may be set based on an equation obtained through an expansion of Equations 1 through 5.

In a related LOS MIMO method, antennas may be disposed to have a predetermined transmission delay such that an inter-path correlation ship is maintained, thereby restoring a signal through reception. According to an aspect of the present invention, it is possible to reduce a size of a system by receiving a combination of a plurality of signals using each antenna, and restore a signal by performing a simple operation on received signals through an LOS channel environment, thereby reducing a distance separating antennas irrespective of a transmission distance and a transmission frequency.

According to another aspect of the present invention, it is possible to achieve a desired result without performance distortion despite a distance difference between transmission antennas and reception antennas and a center alignment between a transmission antenna and a reception antenna.

While this disclosure includes specific examples, it will be apparent to one of ordinary skill in the art that various changes in form and details may be made in these examples without departing from the spirit and scope of the claims and their equivalents. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A multiple-input and multiple-output (MIMO) transmitter comprising:
N transmission antennas,
wherein an output transfer function of the MIMO transmitter is adjusted based on phase difference between a direct path from each of the N transmission antennas to each of the M reception antennas and a delay path from each of the N transmission antennas to each of the M reception antennas.

2. The transmitter of claim 1, wherein the output transfer function is adjusted such that a phase difference between a signal received by each of the M reception antennas through the delay path and a signal received by each of the M reception antennas through the direct path is a multiple of 90 degrees (°).

3. The transmitter of claim 1, wherein each of the M reception antennas is disposed to have an identical difference between the direct path from each of the N reception antennas and the delay path from each of the N reception antennas.

4. The transmitter of claim 1, wherein the N transmission antennas are disposed not to form a center alignment relative to the M reception antennas.

5. The transmitter of claim 1, wherein the N transmission antennas are disposed such that a distance separating the N transmission antennas differs from a distance separating the M reception antennas.

6. The transmitter of claim 1, wherein the output transfer function of the MIMO transmitter is expressed to be H_{adjust}=Hᵣₑₐₗ⁻¹H_{ideal}, and
wherein Hᵣₑₐₗ⁻¹ denotes a reverse function of an actual channel transfer function of the N transmission antennas and the M reception antennas, and H_{ideal} denotes a transfer function through which a phase difference between a signal received through the direct path and a signal received through the delay path is set to be 90°.

7. The transmitter of claim 6, wherein when N is “2” and M is “2”, H_{ideal} is expressed to be
$${H}_{ideal} = [ \begin{matrix}1 & {e}^{i \frac{π}{2}} \\ {e}^{i \frac{π}{2}} & 1\end{matrix} ] ,$$
Hᵣₑₐₗ⁻¹ is expressed to be
$${H}_{real} = [ \begin{matrix}1 & {e}^{i θ} \\ {e}^{i θ} & 1\end{matrix} ] ,$$
and
θ denotes an actual phase difference between the direct path and the delay path.

8. The transmitter of claim 6, wherein when N is “2”, M is “2”, and an actual phase difference between the direct path and the delay path is 45°, the output transfer function is expressed to be
$${H}_{adjust} = [ \begin{matrix}1.3066 {e}^{i \frac{22.5}{180} π} & 0.5412 {e}^{i \frac{202.5}{180} π} \\ 0.5412 {e}^{i \frac{202.5}{180} π} & 1.3066 {e}^{i \frac{22.5}{180} π}\end{matrix} ] .$$

9. The transmitter of claim 6, wherein when N is “2”, M is “2”, and an actual phase difference between the direct path and the delay path is 30°, the output transfer function is expressed to be
$${H}_{adjust} = [ \begin{matrix}1.7321 {e}^{i \frac{30}{180} π} & 1 {e}^{i \frac{210}{180} π} \\ 1 {e}^{i \frac{210}{180} π} & 1.7321 {e}^{i \frac{30}{180} π}\end{matrix} ] .$$

10. The transmitter of claim 6, wherein when N is “2”, M is “2”, and an actual phase difference between the direct path and the delay path is 60°, the output transfer function is expressed to be
$${H}_{adjust} = [ \begin{matrix}1.1154 {e}^{i \frac{15}{180} π} & 0.2989 {e}^{i \frac{195}{180} π} \\ 0.2989 {e}^{i \frac{195}{180} π} & 1.1154 {e}^{i \frac{15}{180} π}\end{matrix} ] .$$

11. A multiple-input and multiple-output (MIMO) communication system comprising:
a transmitter comprising N transmission antennas; and
a receiver comprising M reception antennas,
wherein an output transfer function of the transmitter is adjusted based on a phase difference between a direct path from each of the N transmission antennas to each of the M reception antennas, and a delay path from each of the N transmission antennas to each of the M reception antennas.

12. The system of claim 11, wherein the output transfer function is adjusted such that a phase difference between a signal received by each of the M reception antennas through the direction path, and a signal received by each of the M reception antennas through the delay path is a multiple of 90 degrees (°).

13. The system of claim 11, wherein each of the M reception antennas is disposed to have an identical difference between the direct path from each of the N reception antennas and the delay path from each of the N reception antennas.

14. The system of claim 11, wherein the N transmission antennas are disposed not to form a center alignment relative to the M reception antennas.

15. The system of claim 11, wherein the N transmission antennas are disposed such that a distance separating the N transmission antennas differs from a distance separating the M reception antennas.

16. The system of claim 11, wherein the output transfer function of the MIMO transmitter is expressed to be H_{adjust}=Hᵣₑₐₗ⁻¹H_{ideal}, and wherein Hᵣₑₐₗ⁻¹ denotes a reverse function of an actual channel transfer function of the N transmission antennas and the M reception antennas, and H_{ideal} denotes a transfer function through which a phase difference between a signal received through the direct path and a signal received through the delay path is set to be 90°.
